(19) United States
(12) Patent Application Publication
(10) Pub. No.: US 2025/0214288 A1
(43) Pub. Date: Jul. 3, 2025

(54) INJECTION MOLDING PROCESS

(71) Applicant: SABIC GLOBAL TECHNOLOGIES B.V., Bergen op Zoom (NL)

(72) Inventors: Christelle Marie Helene GREIN, Aachen (DE); Cristina Yolanda RODRIGUEZ IGLESIAS, Maastricht (NL); Marc HERKLOTS, Herten (NL); Markus Willem Henricus FEEKES, Kerkrade (NL); Winke Heidi Werner VAN DEN FONTEYNE, Amsterdam (NL); Jasper Henricus Emanuel PAULUSSEN, Geleen (NL)

(21) Appl. No.: 18/845,726

(22) PCT Filed: Mar. 6, 2023
(86) PCT No.: PCT/EP2023/055612

§ 371 Date: Sep. 10, 2024

(30) Foreign Application Priority Data
Mar. 14, 2022 (EP) 22161853.1

(51) Int. Cl. B29C 45/00; B29K 23/00; B29K 105/00; B29K 509/00

(52) U.S. Cl. CPC B29C 45/0001; B29K 2023/12; B29K 2023/16; B29K 2105/0044; B29K 2509/00; B29K 2995/0012; B29K 2995/0089

(57) ABSTRACT

The invention relates to a process for the preparation of an injection molded article, wherein the process comprise the steps of: i) providing a masterbatch by melt-mixing in an extruder a first heterophasic propylene copolymer having a first melt flow index MFI1 determined according to ISO1133-1:2011 using 2.16 kg at 230° C., an elastomer, an inorganic filler and additives comprising a stabilizer, ii) providing a base composition comprising a second heterophasic propylene copolymer having a second melt flow index MFI2 determined according to ISO1133-1:2011 using 2.16 kg at 230° C., wherein MFI1 and MFI2 are different, iii) providing the injection molded article using an injection molding machine comprising an extruder part and an injection molding part by melt-mixing the masterbatch and the base composition in the extruder part to obtain a melt mixture and processing the melt mixture in the injection molding part to obtain the injection molded article, wherein the first heterophasic propylene copolymer consists of (ia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (ib) a dispersed ethylene-a-olefin copolymer, wherein the sum of the total amount of propylene-based matrix and total amount of the dispersed ethylene-a-olefin copolymer in the heterophasic propylene copolymer is 100 wt % and wherein the second heterophasic propylene copolymer consists of (iia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (iib) a dispersed ethylene-α-olefin copolymer, wherein the sum of the total amount of propylene-based matrix and total amount of the dispersed ethylene-a-olefin copolymer in the heterophasic propylene copolymer is 100 wt %.

The present invention relates to an injection molding process and an injection molded article obtained thereby. The invention further relates to a kit of parts for making the injection molded article. The invention further relates to a masterbatch and its use in an injection molding process.

Injection molded articles prepared from heterophasic propylene copolymer-based compositions are used for various applications. It is known to add various components to a heterophasic propylene copolymer to obtain compositions for the preparation of injection molded articles having different properties. Injection molded articles are typically made by melt-mixing a heterophasic propylene copolymer with the additional components to obtain pellets and feeding these pellets to injection molding machine.

There is a need in the art for an efficient process for the preparation of an injection molded article from a composition based on a heterophasic propylene copolymer.

Accordingly, the present invention provides a process for the preparation of an injection molded article, wherein the process comprises the steps of:
i) providing a masterbatch by melt-mixing in an extruder a first heterophasic propylene copolymer having a first melt flow index MFI1 determined according to ISO1133-1:2011 using 2.16 kg at 230° C., an elastomer, an inorganic filler and additives comprising a stabilizer,
ii) providing a base composition comprising a second heterophasic propylene copolymer having a second melt flow index MFI2 determined according to ISO1133-1:2011 using 2.16 kg at 230° C., wherein MFI1 and MFI2 are different,
iii) providing the injection molded article using an injection molding machine comprising an extruder part and an injection molding part by melt-mixing the masterbatch and the base composition in the extruder part to obtain a melt mixture and processing the melt mixture in the injection molding part to obtain the injection molded article,
wherein the first heterophasic propylene copolymer consists of (ia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (ib) a dispersed ethylene-α-olefin copolymer,
wherein the sum of the total amount of propylene-based matrix and total amount of the dispersed ethylene-α-olefin copolymer in the heterophasic propylene copolymer is 100 wt % and
wherein the second heterophasic propylene copolymer consists of (iia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (iib) a dispersed ethylene-α-olefin copolymer, wherein the sum of the total amount of propylene-based matrix and total amount of the dispersed ethylene-α-olefin copolymer in the heterophasic propylene copolymer is 100 wt %.

According to the process of the present invention, a masterbatch is provided which can be melt-mixed with a base composition in an injection molding machine. Various injection molded article can be obtained with properties adjusted according to needs.

The invention is based on the realization that the use of a masterbatch comprising an elastomer and an inorganic filler results in a substantial saving of energy.

Melt-mixing of all components of the final composition to be injection molded to provide pellets requires a large amount of energy since the amount to be melt-mixed is relatively large, in particular when the final composition comprises an elastomer. This may also require a large extruder. These pellets are then melt-mixed and injection molded in an injection molding machine.

In contrast, the amount to be melt-mixed for obtaining a masterbatch is smaller, which requires less energy. This may also allow the use of a smaller extruder. The masterbatch can be melt-mixed with a base composition in an extruder part of the injection molding machine, after which the final composition is injection molded.

As the energy required in the injection molding machine is not very different between these two methods, the overall energy consumption is smaller according to the process of the invention which involves making a masterbatch which requires less energy.

Furthermore, the use of the masterbatch offers more flexibility for obtaining injection molded articles with different properties. Injection molded articles with different properties can be easily obtained according to the invention simply by adjusting the amount of the masterbatch in relation to the base composition.

### Injection Molding

In the process according to the invention for the preparation of an injection molded article, a masterbatch is provided separately from a base composition by melt-mixing. The masterbatch and the base composition are preferably provided in the form of pellets. Subsequently the masterbatch and the base composition are fed to an injection molding machine.

The injection molding machine comprises an extruder part followed by an injection molding part. The masterbatch and the base composition are fed to the extruder part to obtain a melt mixture. Subsequently the melt mixture is processed in the injection molding part to obtain the injection molded article.

Preferably, the weight ratio between the masterbatch and the base composition is 1:10 to 10:1, for example 1:1 to 10:1, 1:1 to 5:1 or 1:1 to 2:1.

### Masterbatch

The masterbatch comprises a first heterophasic propylene copolymer, an elastomer, an inorganic filler and additives comprising a stabilizer.

Preferably, the amount of the first heterophasic propylene copolymer in the masterbatch with respect to the masterbatch is 40 to 80 wt %, more preferably 50 to 70 wt %.

Preferably, the amount of the elastomer in the masterbatch with respect to the masterbatch is 10 to 35 wt %, more preferably 15 to 30 wt %.

Preferably, the amount of the inorganic filler in the masterbatch with respect to the masterbatch is 5.0 to 40 wt %, more preferably 8.0 to 35 wt %, more preferably 10 to 30 wt %.

Preferably, the amount of the additives in the masterbatch with respect to the masterbatch is 0.01 to 5.0 wt %, more preferably 0.1 to 3.0 wt %.

Preferably, the amount of the stabilizer in the masterbatch with respect to the masterbatch is 0.01 to 2.0 wt %, more preferably 0.1 to 1.0 wt %.

Preferably, the total amount of the first heterophasic propylene, the elastomer, the inorganic filler and the additives in the masterbatch with respect to the masterbatch is at least 90 wt %, at least 95 wt %, at least 98 wt %, at least 99 wt % or 100 wt %.

The first heterophasic propylene copolymer may be a single type of a heterophasic propylene copolymer or a mixture of different types of heterophasic propylene copolymers having different melt flow indexes. In the cases where the first heterophasic propylene copolymer is a mixture of different types of heterophasic propylene copolymers, the properties of the first heterophasic propylene copolymer are calculated as the weighted average of the heterophasic propylene copolymers used.

In some embodiments, the masterbatch further comprises a low density polyethylene. The amount of the low density polyethylene may e.g. be 1.0 to 10 wt % with respect to the total of the first heterophasic propylene copolymer and the low density polyethylene.

### Base Composition

The base composition comprises or consist of a second heterophasic propylene copolymer.

Preferably, the amount of the second heterophasic propylene copolymer in the base composition with respect to the base composition is 93 to 100 wt % or 94 to 99.5 wt %, for example at least 95 wt %, at least 97 wt % or at least 98 wt %.

The base composition may further comprise additives comprising a stabilizer.

Preferably, the amount of the additives in the base composition with respect to the base composition is 0.01 to 5.0 wt %, more preferably 0.1 to 3.0 wt %.

Preferably, the amount of the stabilizer in the base composition with respect to the base composition is 0.01 to 1.0 wt %, more preferably 0.1 to 2.0 wt %.

The second heterophasic propylene copolymer may be a single type of a heterophasic propylene copolymer or a mixture of different types of heterophasic propylene copolymers having different melt flow indexes. In the cases where the second heterophasic propylene copolymer is a mixture of different types of heterophasic propylene copolymers, the properties of the second heterophasic propylene copolymer are calculated as the weighted average of the heterophasic propylene copolymers used.

In some embodiments, the base composition further comprises a low density polyethylene. The amount of the low density polyethylene may e.g. be 1.0 to 10 wt % with respect to the total of the second heterophasic propylene copolymer and the low density polyethylene.

Amounts with Respect to Total

Preferably, the amount of the first heterophasic propylene copolymer with respect to the injection molded article is 10 to 50 wt %, more preferably 20 to 40 wt %.

Preferably, the amount of the elastomer with respect to the injection molded article is 5.0 to 20 wt %, more preferably 8.0 to 12 wt %.

Preferably, the amount of the inorganic filler with respect to the injection molded article is 5.0 to 30 wt %, more preferably 8.0 to 22 wt %, more preferably 8.0 to 17 wt %.

Preferably, the amount of the additives with respect to the injection molded article is 0.01 to 5.0 wt %, more preferably 0.1 to 3.0 wt %.

Preferably, the amount of the stabilizer with respect to the injection molded article is 0.01 to 1.0 wt %, more preferably 0.1 to 2.0 wt %.

Preferably, the amount of the second heterophasic propylene copolymer with respect to the injection molded article is 30 to 80 wt %, more preferably 40 to 70 wt %.

Preferably, the total amount of the first heterophasic propylene, the elastomer, the inorganic filler, the additives and the second heterophasic propylene copolymer with respect to the injection molded article is at least 95 wt %, at least 98 wt %, at least 99 wt % or 100 wt %.

In the cases where the base composition comprises optional components such as additives (stabilizer), the amounts of e.g. the additives in the injection molded article are calculated as the total amounts of the additives in the masterbatch and in the base composition.

Preferably, the total amount of the masterbatch and the base composition with respect to the injection molded article is 100 wt %.

### First and Second Heterophasic Propylene Copolymer

The first heterophasic propylene copolymer has a first melt flow index MFI1 determined according to ISO1133-1:2011 using 2.16 kg at 230° C. and the second heterophasic propylene copolymer has a second melt flow index MFI2 determined according to ISO1133-1:2011 using 2.16 kg at 230° C. MFI1 and MFI2 are different.

Preferably, the ratio of MFI1 to MFI2 or the ratio of MFI2 to MFI1 is at least 5.0, more preferably at least 5.5, more preferably at least 5.8, more preferably at least 5.9, more preferably at least 6.0. It was found that such high ratio results in a good puncture impact toughness of the injection molded article according to the invention and a good processibility during injection molding.

The first heterophasic propylene copolymer has a first Charpy impact strength IS1 according to IS0179/1eA (II) at 23° C. and the second heterophasic propylene copolymer has a second Charpy impact strength IS2 according to IS0179/1eA (II) at 23° C. IS1 and IS2 are typically different.

Preferably, the ratio of IS1 to IS2 or the ratio of IS2 to IS1 is at least 5.0, more preferably at least 6.0.

In some embodiments, MFI1>MFI2 and IS1<IS2. In some embodiments, the ratio of MFI1 to MFI2 is at least 5.0, more preferably at least 5.5, more preferably at least 5.8, more preferably at least 5.9, more preferably at least 6.0 and the ratio of IS2 to IS1 is at least 5.0, more preferably at least 6.0.

In some embodiments, MFI1<MFI2 and IS1>IS2. In some embodiments, the ratio of MFI2 to MFI1 is at least 5.0, more preferably at least 5.5, more preferably at least 5.8, more preferably at least 5.9, more preferably at least 6.0 and the ratio of IS1 to IS2 is at least 5.0, more preferably at least 6.0.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer. These steps are preferably performed in different reactors. The catalyst systems for the first step and for the second step may be different or same.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-a-olefin copolymer may be determined by ¹³C-NMR, as well known in the art.

In the heterophasic propylene copolymer in the composition of the invention, the sum of the total weight of the propylene-based matrix and the total weight of the dispersed ethylene-α-olefin copolymer is 100 wt % of the heterophasic propylene copolymer.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexene, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexene, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer

The heterophasic propylene copolymer may be obtained directly from the reactor(s), but may also be prepared by visbreaking an intermediate heterophasic propylene copolymer prepared in a sequential multi-reactor polymerization process and having an initial melt flow rate (MFRᵢ) as determined according to ISO1133:2011 using 2.16 kg at 230° C. by contacting said intermediate heterophasic propylene copolymer in a melt mixing process with a peroxide to form the heterophasic propylene copolymer having a melt flow rate (MFR_{HECO}) as determined according to ISO1133:2011 using 2.16 kg at 230° C. with a visbreaking ratio MFR_{HECO}/MFRᵢ in the range from 1.2 to 25.

### Catalyst System

Ziegler-Natta catalyst systems are well known in the art. The term normally refers to catalyst systems comprising a transition metal containing solid catalyst compound (procatalyst) and an organo-metal compound (co-catalyst). Optionally one or more electron donor compounds (external donor) may be added to the catalyst system as well.

The transition metal in the transition metal containing solid catalyst compound is normally chosen from groups 4-6 of the Periodic Table of the Elements (Newest IUPAC notation); more preferably, the transition metal is chosen from group 4; the greatest preference is given to titanium (Ti) as transition metal.

Although various transition metals are applicable, the following is focused on the most preferred one being titanium. It is, however, equally applicable to the situation where other transition metals than Ti are used. Titanium containing compounds useful in the present invention as transition metal compound generally are supported on hydrocarbon-insoluble, magnesium and/or an inorganic oxide, for instance silicon oxide or aluminum oxide, containing supports, generally in combination with an internal electron donor compound. The transition metal containing solid catalyst compounds may be formed for instance by reacting a titanium (IV) halide, an organic internal electron donor compound and a magnesium and/or silicon containing support. The transition metal containing solid catalyst compounds may be further treated or modified with an additional electron donor or Lewis acid species and/or may be subjected to one or more washing procedures, as is well known in the art.

Some examples of Ziegler-Natta (pro)catalysts and their preparation method which can suitably be used to prepare the heterophasic propylene copolymer (A) can be found in EP 1 273 595, EP 0 019 330, U.S. Pat. No. 5,093,415, Example 2 of U.S. Pat. Nos. 6,825,146, 4,771,024 column 10, line 61 to column 11, line 9, WO03/068828, U.S. Pat. No. 4,866,022, WO96/32426A, example I of WO 2007/134851 A1 and in WO2015/091983 all of which are hereby incorporated by reference.

The (pro)catalyst thus prepared can be used in polymerization of the heterophasic propylene copolymer using an external donor, for example as exemplified herein, and a co-catalyst, for example as exemplified herein.

In one embodiment, the heterophasic propylene copolymer is made using a catalyst which is free of phthalate.

It is preferred to use so-called phthalate free internal donors because of increasingly stricter government regulations about the maximum phthalate content of polymers. In the context of the present invention, “essentially phthalate-free” or “phthalate-free” means having a phthalate content of less than for example 150 ppm, alternatively less than for example 100 ppm, alternatively less than for example 50 ppm, alternatively for example less than 20 ppm, for example of 0 ppm based on the total weight of the catalyst. Examples of phthalates include but are not limited to a dialkylphthalate esters in which the alkyl group contains from about two to about ten carbon atoms. Examples of phthalate esters include but are not limited to diisobutylphthalate, ethylbutylphthalate, diethylphthalate, di-n-butylphthalate, bis(2-ethylhexyl)phthalate, and diisodecylphthalate.

Examples of phthalate free internal donors include but are not limited to 1,3-diethers, for example 9,9-bis(methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures thereof.

The catalyst system comprising the Ziegler-Natta pro-catalyst may be activated with an activator, for example an activator chosen from the group of benzamides and monoesters, such as alkylbenzoates.

The catalyst system includes a co-catalyst. As used herein, a “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst as are known to the skilled person. Preferably, the cocatalyst is selected from trimethylaluminium, triethylaluminum, triisobutylaluminum, trihexylaluminum, di-isobutylaluminum hydride, trioctylaluminium, dihexylaluminum hydride and mixtures thereof, most preferably, the cocatalyst is triethylaluminium (abbreviated as TEAL).

Examples of external donors are known to the person skilled in the art and include but are not limited to external electron donors chosen from the group of compounds having a structure according to Formula III (R⁹⁰)₂N—Si(OR⁹¹)₃, compounds having a structure according to Formula IV: (R⁹²)Si(OR⁹³)₃ and mixtures thereof, wherein each of R⁹⁰, R⁹¹,R⁹² and R⁹³ groups are each independently a linear, branched or cyclic, substituted or unsubstituted alkyl having from 1 to 10 carbon atoms, preferably wherein R⁹⁰, R⁹¹, R⁹² and R⁹³ groups are each independently a linear unsubstituted alkyl having from 1 to 8 carbon atoms, for example ethyl, methyl or n-propyl, for example diethylaminotriethoxysilane (DEATES), n-propyl triethoxysilane, (nPTES), n-propyl trimethoxysilane (nPTMS); and organosilicon compounds having general formula Si(OR^{a})₄₋ₙR^{b}, wherein n can be from 0 up to 2, and each of R^{a} and R^{b}, independently, represents an alkyl or aryl group, optionally containing one or more hetero atoms for instance O, N, S or P, with, for instance, 1-20 carbon atoms; such as diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl) dimethoxysilane (DiPDMS). More preferably, the external electron donor is chosen from the group of di(iso-propyl) dimethoxysilane (DiPDMS) or diisobutyl dimethoxysilane (DiBDMS).

Preferably, the heterophasic propylene copolymer is produced in a sequential multi-reactor polymerization process, for example in a gas-phase process, in the presence of a) a Ziegler-Natta catalyst comprising compounds of a transition metal of Group 4 to 6 of IUPAC, a Group 2 metal compound and an internal donor, wherein said internal donor preferably is a non-phthalic compound, more preferably a non-phthalic acid ester, even more preferably wherein said internal donor is selected from the group of 1,3-diethers, for example 9,9-bis(methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures;
b) a co-catalyst (Co), and
c) optionally an external donor.

### CRYSTEX Method

The CRYSTEX method described in WO2019179959 and hereinbelow can determine the following properties of a heterophasic propylene copolymer:
ethylene content in the heterophasic propylene copolymer (TC2 whole);
intrinsic viscosity of the heterophasic propylene copolymer (IV whole);
amount of crystalline insoluble fraction in the heterophasic propylene copolymer (CXI equiv. whole sample; HT fraction);
amount of amorphous soluble fraction in the heterophasic propylene copolymer (CXS equiv. whole sample; LT fraction);
ethylene content in the crystalline insoluble fraction (TC2-HT fraction);
ethylene content in the amorphous soluble fraction (TC2-LT fraction);
intrinsic viscosity of the crystalline insoluble fraction (IV-HT fraction);
intrinsic viscosity of the amorphous soluble fraction (IV-LT fraction).

The measurement of these properties may be performed according to CRYSTEX method by a CRYSTEX QC instrument of CRYSTEX QC Polymer Char (Valencia, Spain). A schematic representation of the CRYSTEX QC instrument is presented in Del Hierro, P.; Ortin, A.; Monrabal, B.; ‘Soluble Fraction Analysis in polypropylene, The Column’, February 2014. Pages 18-23.

The CRYSTEX QC instrument comprises an infrared detector (IR4) and an online 2-capillary viscometer. Quantification of HT fraction, LT fraction, TC2 whole, TC2-HT fraction, TC2-LT fraction can be done by the infrared detector which detects IR absorbance at two different bands (CH3 and CH2). IV whole, IV-HT fraction, IV-LT fraction can be determined by the online 2—capillary viscometer.

A sample of the heterophasic propylene copolymer to be analyzed is weighed in concentrations of 5 mg/mL. After automated filling of the vial with 1,2,4-TCB containing 250 mg/L 2,6-tert-butyl-4-methylphenol (BHT) as antioxidant, the sample is dissolved at 170° C. until complete dissolution is achieved, for 120 min, with constant stirring of 800 rpm.

A defined volume of the sample solution is injected into the column filled with inert support where the crystallization of the sample and separation of the soluble fraction from the crystalline part takes place. This process is repeated twice.

During the first injection the whole sample is subjected to measurements at high temperature, for determining the IV whole [dl/g] and the TC2 whole (m/m %) of the heterophasic propylene copolymer.

During the second injection a measurement at low temperature is performed for determining TC2 LT (m/m %), IV LT [dl/g] and amorphous soluble fraction (CXS equiv. whole sample) (m/m %), followed by a measurement at high temperature for determining the TC2 HT fraction (m/m %), IV HT fraction [dl/g] and crystalline insoluble fraction (CXI equiv. whole sample (m/m %)).

The crystalline insoluble fraction and the amorphous soluble fraction are separated through temperature cycles of dissolution at 165° C., crystallization at 40° C. and re-dissolution in 1,2,4-trichlorobenzene (1,2,4-TCB) at 165° C.

HT fraction and LT fraction are determined by calibrating the measurement results using the Cold Xylene Soluble (CXS) and Cold Xylene Insoluble (CXI) fractions of various heterophasic propylene copolymers with known CXS content in the range 8 to 35 wt % determined according to standard gravimetric method according to IS016152.

TC2 whole, TC2-HT fraction TC2-LT fraction are determined by calibrating the measurement results using mixtures of Sabic HDPE M200056 and Sabic PP homopolymer 520P with known ethylene content in the range of 0 wt.-% to 50 wt.-%

IV whole, IV-HT fraction, IV-LT fraction are determined by calibrating the measurement results using several commercial ethylene-propylene copolymers having IV whole, IV-HT fraction and IV-LT fraction varying between 1 and 6 dL/g determined according to ISO-1628-1 and -3 in decalin at 135° C.

### HECO-A and HECO-B

Hereinbelow, two types of heterophasic propylene copolymer (HECO-A and HECO-B) suitable for use in the present invention are described in detail. HECO-A and HECO-B are suitable either as the first heterophasic propylene copolymer or the second heterophasic propylene copolymer. In some embodiments, the first heterophasic propylene copolymer is HECO-A and the second heterophasic propylene copolymer is HECO-B. In other embodiments, the first heterophasic propylene copolymer is HECO-B and the second heterophasic propylene copolymer is HECO-A.

### HECO-A

Preferably, the HECO-A has a melt flow rate as determined according to ISO1133-1:2011 using 2.16 kg at 230° C. in the range greater than 25 dg/min and at most 120 dg/min, more preferably 30 to 110 dg/min, more preferably 40 to 100 dg/min.

Preferably, the HECO-A has a Charpy impact strength determined by IS0179/1eA (II) at 23° C. of 3.0 to 15 kJ/m2.

Preferably, the dispersed ethylene-α-olefin copolymer is present in the HECO-A in an amount of 10 to 40 wt %, for example 10 to 20 wt % or 20 to 30 wt %. The amount of the dispersed ethylene-α-olefin copolymer in the heterophasic propylene copolymer may herein be sometimes referred as RC.

Preferably, the amount of ethylene monomer units in the ethylene-α-olefin copolymer in the HECO-A is 20 to 60 wt %, preferably 30 to 55 wt %, for example 40 to 50 wt %. The amount of ethylene monomer units in the dispersed ethylene-α-olefin copolymer in the heterophasic propylene copolymer may herein be sometimes referred as RCC2.

The HECO-A may have an Mw/Mn in the range from 3.0 to 11.0, for example in the range from 4.0 to 9.0, wherein Mw stands for the weight average molecular weight and Mn stands for the number average weight and wherein Mw and Mn are measured according to IS016014-1(4):2003.

The HECO-A can be separated into an amorphous soluble fraction and a crystalline insoluble fraction according to CRYSTEX QC method described herein.

Preferably, the HECO-A has a soluble fraction having an intrinsic viscosity determined by an online 2-capillary viscometer according to CRYSTEX QC method described herein of 1.50 to 3.50 dL/g, for example 1.60 to 3.20 dL/g.

Preferably, the HECO-A has an insoluble fraction having an intrinsic viscosity determined by an online 2-capillary viscometer according to CRYSTEX QC method described herein of 0.85 to 1.15 dL/g, for example 0.90 to 1.10 dL/g.

### HECO-B

Preferably, the HECO-B has a melt flow rate as determined according to ISO1133-1:2011 using 2.16 kg at 230° C. in the range from 1.0 to 25 dg/min, for example 2.0 to 20 dg/min, 3.0 to 15 dg/min, 5.0 to 12 dg/min.

Preferably, the HECO-B has a Charpy impact strength determined by IS0179/1eA (II) at 23° C. of at least 50 kJ/m².

Preferably, the dispersed ethylene-α-olefin copolymer in the HECO-B is present in an amount of 20 to 50 wt %, preferably 30 to 40 wt %.

Preferably, the amount of ethylene monomer units in the ethylene-α-olefin copolymer in the HECO-B is 45 to 65 wt %, preferably 50 to 60 wt %.

The HECO-B may have an Mw/Mn in the range from 3.0 to 11.0, for example in the range from 4.0 to 9.0, wherein Mw stands for the weight average molecular weight and Mn stands for the number average weight and wherein Mw and Mn are measured according to IS016014-1(4):2003.

The HECO-B can be separated into an amorphous soluble fraction and a crystalline insoluble fraction according to the CRYSTEX method described herein.

Preferably, the HECO-B has a soluble fraction having an intrinsic viscosity determined by an online 2-capillary viscometer according to CRYSTEX QC method described herein of 1.50 to 3.50 dL/g, for example 1.60 to 3.20 dL/g.

Preferably, the HECO-B has an insoluble fraction having a soluble fraction having an intrinsic viscosity determined by an online 2-capillary viscometer according to CRYSTEX QC method described herein of 1.20 to 2.00 dL/g, for example 1.25 to 1.95 dL/g.

### Elastomer

Preferably, the elastomer is a copolymer of ethylene and an α-olefin comonomer having 4 to 8 carbon atoms. Preferably, the elastomer has a density of 0.850 to 0.915 g/cm³.

The a-olefin comonomer in the elastomer is preferably an acyclic monoolefin such as 1-butene, 1-pentene, 1-hexene, 1-octene, or 4-methylpentene.

Accordingly, the elastomer is preferably selected from the group consisting of ethylene-1-butene copolymer, ethylene-1-hexene copolymer, ethylene-1-octene copolymer and mixtures thereof. More preferably, the elastomer is selected from ethylene-1-butene copolymer and ethylene-1-octene copolymer.

Preferably, the density of the elastomer is 0.855 to 0.900 g/cm³, more preferably 0.855 to 0.880 g/cm³. In some embodiments, the density of the elastomer is 0.855 to 0.865 g/cm³. In some embodiments, the density of the elastomer is 0.865 to 0.880 g/cm³.

Preferably, the elastomer has a melt flow index according to ISO1133:2011 using 2.16 kg at 190° C. of 0.1 to 40 dg/min. The melt flow index according to ISO1133:2011 using 2.16 kg at 190° C. of the elastomer may e.g. be 0.1 to 3.0 dg/min, 3.0 to 10 dg/min or 10 to 40 dg/min.

Preferably, the amount of ethylene in the elastomer is at least 50 mol %. More preferably, the amount of ethylene in the elastomer is at least 57 mol %, for example at least 60 mol %, at least 65 mol % or at least 70 mol %. Even more preferably, the amount of ethylene in the elastomer is at least 75 mol %. In these ranges, particularly good transparency (and low haze) is obtained. The amount of ethylene in the elastomer may typically be at most 97.5 mol %, for example at most 95 mol % or at most 90 mol %.

Elastomers which are suitable for use in the current invention are commercially available for example under the trademark EXACT™ available from Exxon Chemical Company of Houston, Texas or under the trademark ENGAGE™ polymers, a line of metallocene catalyzed plastomers available from Dow Chemical Company of Midland, Michigan or from Nexlene™ from SK Chemicals The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the total amount of the elastomer, the dispersed ethylene-α-olefin copolymer in the first heterophasic propylene copolymer and the dispersed ethylene-α-olefin copolymer in the second heterophasic propylene copolymer with respect to the injection molded article is 25 to 45 wt %, for example 30 to 40 wt %.

The elastomer may be a single type of an elastomer or a mixture of different types of elastomers having different melt flow indexes and/or densities. In the cases where the elastomer is a mixture of different types of elastomers, the properties of the elastomer are calculated as the weighted average of the elastomers used.

### Inorganic Filler

Suitable examples of the inorganic filler in the masterbatch and the optional inorganic filler in the base composition according to the invention include talc, calcium carbonate, wollastonite, barium sulphate, kaolin, glass flakes, laminar silicates (bentonite, montmorillonite, smectite) and mica. For example, the inorganic filler is chosen from the group of talc, calcium carbonate, wollastonite, mica and mixtures thereof. More preferably, the inorganic filler is talc.

Preferably, the inorganic filler has a median diameter d50 determined according to IS013320-1:2020 of 5 to 20 μm, preferably 3 to 15 μm.

### Additives

The additives include a stabilizer. The stabilizer may e.g. be selected from heat stabilisers, anti-oxidants and/or UV stabilizers. Examples include common stabilizers such as Irgafos 168, Irganox 1010 and/or Irganox B225.

The additives may further include nucleating agents, colorants, like pigments and dyes; clarifiers; surface tension modifiers; lubricants; flame-retardants; mould-release agents; flow improving agents; plasticizers; anti-static agents; blowing agents; slip agents.

### LDPE

Preferably, the low density polyethylene (LDPE) has a density in the range from 915 to 932 kg/m³ as measured according to IS01872-2:2007. More preferably, the LDPE has a density in the range from 915 to 928 kg/m³, most preferably in the range from 918 to 922 kg/m³ as measured according to IS01183-1:2012 at 23° C.

Preferably, the low density polyethylene has a melt flow rate (MFR_{LDPE, 230}) as determined according to ISO1133:2011 using 2.16 kg at 230° C. in the range from 0.30 to 20 dg/min, preferably in the range from 1.0 to 15 dg/min, more preferably in the range from 1.5 to 10 dg/min.

Preferably, the low density polyethylene (B) has a melt flow rate as determined according to ISO1133:2011 using 2.16 kg at 190° C. (MFR_{LDPE, 190}) in the range from 0.10 to 5.0 dg/min, preferably in the range from 0.20 to 3.8 dg/min.

LDPE applied in the invention may be produced by use of autoclave high pressure technology or by tubular reactor technology. An example of a suitable LDPE is the commercially available SABIC® LDPE 2201H0.

The invention further provides a kit of parts for making the injection molded article according to the invention, comprising the masterbatch and the base composition

### Applications

Preferably, the injection molded article according to the invention is an automotive part, preferably an exterior automotive part such as a bumper.

Properties of composition consisting of masterbatch and base composition Preferably, a composition consisting of the masterbatch and the base composition in the amounts used in the process according to the invention has one or more of the following properties (when a test specimen is made from the masterbatch and the base composition melt-mixed at the ratio used in the process according to the invention, the test specimen has one or more of the following properties):
a break type value of at least 1.2, preferably at least 2.0, more preferably at least 2.4, more preferably at least 2.6, wherein the break type value is determined by determining the break type of 5 samples according to instrumental falling weight (IFW) test according to ISO 6603-2 at −20° C. using injection moulded plaques of 65×65×3.2 mm, a dart height of 1000 mm and a dart weight of 20 kg where values of 4, 3, 2 and 1 are respectively assigned to break types YD, YS, YU and NY and taking the average of the five values;
a melt flow index MFI determined according to ISO1133-1:2011 using 2.16 kg at 230° C. of at least 13.0 dg/min, preferably at least 15.0 dg/min and
a puncture energy determined by instrumental falling weight (IFW) test according to ISO 6603-2 at −20° C. using injection moulded plaques of 65×65×3.2 mm, a dart height of 1000 mm and a dart weight of 20 kg of at least 50 J.

The invention further provides a masterbatch comprising a heterophasic propylene copolymer, an elastomer, a filler and a stabilizer, wherein the heterophasic propylene copolymer is HECO-A or HECO-B, wherein HECO-A has a melt flow rate as determined according to ISO1133-1:2011 using 2.16 kg at 230° C. of greater than 25 and at most 120 dg/min and a Charpy impact strength determined by ISO179/1eA (II) at 23° C. after 7 days of 3.0 to 15 kJ/m2 and HECO-B has a melt flow rate as determined according to ISO1133-1:2011 using 2.16 kg at 230° C. of 1.0 to 25 dg/min and a Charpy impact strength determined by ISO179/1eA (II) at 23° C. of at least 50 kJ/mz.

The invention further provides a kit of parts for making an injection molded article comprising a masterbatch and a base composition,
the masterbatch comprises a first heterophasic propylene copolymer having a first melt flow index MFI1 determined according to ISO1133-1:2011 using 2.16 kg at 230° C., an elastomer, an inorganic filler and additives comprising a stabilizer, and
the base composition comprises a second heterophasic propylene copolymer having a second melt flow index MFI2 determined according to ISO1133-1:2011 using 2.16 kg at 230° C.,
wherein MFI1 and MFI2 are different,
wherein the masterbatch and the base composition are provided at the same time or separately.

“Separately” is mentioned in the sense of time and/or location. For example, the masterbatch and the base composition can be provided by the same supplier or by different suppliers at different times and/or different locations.

The invention further provides use of the masterbatch according to the invention or the kit of the present invention for the preparation of an injection molded article with an improved break type value, wherein the break type value is determined by determining the break type of 5 samples according to instrumental falling weight (IFW) test according to ISO 6603-2 at −20° C. using injection moulded plaques of 65×65×3.2 mm, a dart height of 1000 mm and a dart weight of 20 kg where values of 4, 3, 2 and 1 are respectively assigned to break types YD, YS, YU and NY and taking the average of the five values.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

Following materials were used:

### Heterophasic Propylene Copolymers and Homopolymer

| | | | | | | Charpy |
|---|---|---|---|---|---|---|
| | MFI | | | IV-LT | IV-HT | impact |
| | (dg/ | RC | RCC2 | fraction | fraction | strength |
| | min) | (wt %) | (wt %) | (dL/g) | (dL/g) | (kJ/m²) |
| HECO1 | 5.5 | 35 | 51.5 | 2.35 | 1.89 | 75.0 |
| HECO2 | 10 | 35 | 51.5 | 2.17 | 1.61 | 70.0 |
| HECO3 | 22 | 35 | 51.5 | 2.00 | 1.27 | 64.2 |
| HECO4 | 60 | 24 | 48 | 2.12 | 1.04 | 9.7 |
| HECO5 | 60 | 21 | 53 | 1.80 | 0.99 | 9.4 |
| HECO6 | 60 | 26 | 44 | 3.11 | 1.06 | 10.0 |
| HECO7 | 80 | 26 | 44 | 2.83 | 1.01 | 9.2 |
| HECO8 | 100 | 13.5 | 49 | 2.06 | 0.92 | 5.1 |
| HECO9 | 14 | 26 | 44 | 4.60 | 1.30 | 14.5 |
| HECO10 | 40 | 35 | 51.5 | | | 55.1 |
| HECO11 | 20 | 37 | 42 | 2.29 | 1.30 | 64.3 |
| HECO12 | 20 | 24.5 | 56.5 | 2.31 | 1.40 | 24.6 |
| HECO13 | 15 | 35 | 51.5 | 2.33 | 1.38 | 67.1 |
| homo | 150 | — | — | — | — | 1.3 |

### MFI: ISO1133-1:2011, 2.16 kg, 230° C.

LT-fraction-IV and HT-fraction-IV are determined according to the CRYSTEX method. Each of HECO1 to HECO13 is a mixture of a heterophasic propylene copolymer and e.g. stabilizers. The amount of the heterophasic propylene copolymer in each of HECO1 to HECO13 is at least 98 wt %, except for HECO6 which contains LOPE in an amount of 5 wt % and in which the amount of the heterophasic propylene copolymer is about 94 wt %. For HECO6, RC and RCC2 indicated are those of the heterophasic propylene copolymer in each of HECO6 (i.e. RC and RCC2 measured without LOPE). Charpy impact strength is according to Charpy ISO179/1eA (II)@23° C. after 7 days. Each of the heterophasic propylene copolymer in HECO1 to HECO13 comprises a propylene-based matrix which is a propylene homopolymer.

Elastomers (copolymer of ethylene and α-olefin comonomer)

| | | MFI (dg/min) | |
|---|---|---|---|
| | density | ISO1133: 2011 | |
| | (kg/m³) | 2.16 kg, 190° C. | comonomer |
| POE1 | 860 | 0.5 | 1-butene |
| POE2 | 870 | 30 | 1-octene |
| POE3 | 870 | 5 | 1-octene |

### Filler

LUZENAC HAIR T84: talc with a median diameter d50 determined according to ISO13320-1:2020 of 10 μm
Additives: Stabilizers (IRGANOXB225), nucleating agent (NA), slip agent, color masterbatch black

The components as shown in Tables 2 and 3 were melt-mixed to obtain pellets of masterbatches. These pellets and pellets of a base composition consisting of components as shown in Table 1 were fed to the extruder part of an injection molding machine. The amounts in the Tables are indicated by wt % with respect to the total of the masterbatch and the base composition. Injection molded articles were obtained and the properties in Table 4 were measured.

TABLE 1
second heterophasic propylene copolymer in base composition

| | HECO | HECO | HECO | HECO | HECO | HECO | HECO | HECO | HECO |
|---|---|---|---|---|---|---|---|---|---|
| | 2 | 3 | 4 | 5 | 7 | 9 | 10 | 11 | 12 |
| Ex1 | 45.7 | 0 | 0 | 0 | 0 | 0 | 0 | 0 | 0 |
| Ex2 | 50 | 0 | 0 | 0 | 0 | 0 | 0 | 0 | 0 |
| Ex3 | 45 | 0 | 0 | 0 | 0 | 0 | 0 | 0 | 0 |
| Ex4 | 55 | 0 | 0 | 0 | 0 | 0 | 0 | 0 | 0 |
| CEx5 | 46.7 | 0 | 0 | 0 | 0 | 0 | 0 | 0 | 0 |
| Ex6 | 0 | 45.7 | 0 | 0 | 0 | 0 | 0 | 0 | 0 |
| Ex7 | 0 | 0 | 44.7 | 0 | 0 | 0 | 0 | 0 | 0 |
| Ex8 | 0 | 0 | 39.3 | 0 | 0 | 0 | 0 | 0 | 0 |
| Ex9 | 0 | 0 | 44.7 | 0 | 0 | 0 | 0 | 0 | 0 |
| Ex10 | 0 | 0 | 0 | 44.7 | 0 | 0 | 0 | 0 | 0 |
| Ex11 | 0 | 0 | 0 | 55 | 0 | 0 | 0 | 0 | 0 |
| Ex12 | 0 | 0 | 0 | 0 | 44.7 | 0 | 0 | 0 | 0 |
| Ex13 | 0 | 0 | 0 | 0 | 0 | 38.7 | 0 | 0 | 0 |
| Ex14 | 0 | 0 | 0 | 0 | 0 | 0 | 48.7 | 0 | 0 |
| CEx15 | 0 | 53.7 | 0 | 0 | 0 | 0 | 0 | 0 | 0 |
| CEx16 | 0 | 0 | 0 | 0 | 0 | 0 | 0 | 83.7 | 0 |
| CEx17 | 0 | 0 | 0 | 0 | 0 | 0 | 0 | 0 | 73.7 |
| Ex18 | 0 | 48.7 | 0 | 0 | 0 | 0 | 0 | 0 | 0 |
| Ex19 | 0 | 58.7 | 0 | 0 | 0 | 0 | 0 | 0 | 0 |

TABLE 2
first heterophasic propylene copolymer in masterbatch

| | HECO | | HECO | HECO | HECO | HECO | HECO | HECO | HECO |
|---|---|---|---|---|---|---|---|---|---|
| | 8 | homo | 2 | 3 | 1 | 6 | 9 | 12 | 13 |
| Ex1 | 28 | 0 | 0 | 0 | 0 | 0 | 0 | 0 | 0 |
| Ex2 | 23.7 | 0 | 0 | 0 | 0 | 0 | 0 | 0 | 0 |
| Ex3 | 33.7 | 0 | 0 | 0 | 0 | 0 | 0 | 0 | 0 |
| Ex4 | 25.7 | 0 | 0 | 0 | 0 | 0 | 0 | 0 | 0 |
| CEx5 | 0 | 24 | 0 | 0 | 0 | 0 | 0 | 0 | 0 |
| Ex6 | 28 | 0 | 0 | | 0 | 0 | 0 | 0 | 0 |
| Ex7 | 0 | 0 | 29 | 0 | 0 | 0 | 0 | 0 | 0 |
| Ex8 | 0 | 0 | 34.4 | 0 | 0 | 0 | 0 | 0 | 0 |
| Ex9 | 0 | 0 | 0 | 29 | 0 | 0 | 0 | 0 | 0 |
| Ex10 | 0 | 0 | 29 | 0 | 0 | 0 | 0 | 0 | 0 |
| Ex11 | 0 | 0 | 0 | 0 | 21.6 | 0 | 0 | 0 | 0 |
| Ex12 | 0 | 0 | 29 | 0 | 0 | 0 | 0 | 0 | 0 |
| Ex13 | 0 | 0 | 0 | 0 | 0 | 31 | 0 | 0 | 0 |
| Ex14 | 0 | 0 | 0 | 0 | 0 | 0 | 27 | 0 | 0 |
| CEx15 | 0 | 0 | 0 | 0 | 0 | 0 | 0 | 0 | 30 |
| CEx16 | 0 | 0 | 0 | 0 | 0 | 0 | 0 | 0 | 0 |
| CEx17 | 0 | 0 | 0 | 0 | 0 | 0 | 0 | 0 | 0 |
| Ex18 | 0 | 0 | 0 | 0 | 0 | 0 | 0 | 27 | 0 |
| Ex19 | 0 | 0 | 0 | 0 | 0 | 0 | 0 | 19 | 0 |

TABLE 3
other components in masterbatch

| | | | | | | | Slip | |
|---|---|---|---|---|---|---|---|---|
| | POE1 | POE2 | POE3 | filler | NA | stabilizer | agent | color |
| Ex1 | 0 | 0 | 10 | 15 | 0 | 0.2 | 0.1 | 1 |
| Ex2 | 0 | 0 | 10 | 15 | 0 | 0.2 | 0.1 | 1 |
| Ex3 | 5 | 0 | 5 | 10 | 0 | 0.2 | 0.1 | 1 |
| Ex4 | 0 | 0 | 8 | 10 | 0 | 0.2 | 0.1 | 1 |
| CEx5 | 0 | 0 | 13 | 15 | 0 | 0.2 | 0.1 | 1 |
| Ex6 | 0 | 0 | 10 | 15 | 0 | 0.2 | 0.1 | 1 |
| Ex7 | 5 | 0 | 5 | 15 | 0 | 0.2 | 0.1 | 1 |
| Ex8 | 0 | 5 | 5 | 15 | 0 | 0.2 | 0.1 | 1 |
| Ex9 | 5 | 0 | 5 | 15 | 0 | 0.2 | 0.1 | 1 |
| Ex10 | 5 | 0 | 5 | 15 | 0 | 0.2 | 0.1 | 1 |
| Ex11 | 7 | 0 | 5 | 10 | 0.1 | 0.2 | 0.1 | 1 |
| Ex12 | 5 | 0 | 5 | 15 | 0 | 0.2 | 0.1 | 1 |
| Ex13 | 0 | 0 | 14 | 15 | 0 | 0.2 | 0.1 | 1 |
| Ex14 | 4 | 0 | 4 | 15 | 0 | 0.2 | 0.1 | 1 |
| CEx15 | 0 | 0 | 0 | 15 | 0 | 0.2 | 0.1 | 1 |
| CEx16 | 0 | 0 | 0 | 15 | 0.1 | 0.2 | 0.1 | 1 |
| CEx17 | 0 | 0 | 10 | 15 | 0 | 0.2 | 0.1 | 1 |
| Ex18 | 4 | 0 | 4 | 15 | 0 | 0.2 | 0.1 | 1 |
| Ex19 | 0 | 0 | 6 | 15 | 0 | 0.2 | 0.1 | 1 |

TABLE 4
properties: MFI ratio, total MFI, Charpy, VEM break type, VEM value

| | | ash | MFI | | Flexural | break | Puncture |
|---|---|---|---|---|---|---|---|
| | MFI | content | (dg/ | Charpy | modulus | type | energy |
| | ratio | (%) | min) | (kJ/m²) | (MPa) | value | (J) |
| Ex1 | 10.0 | 16 | 16 | 51 | 1720 | 2.4 | 56 |
| Ex2 | 10.0 | 15 | 15 | 56 | 1715 | 3.0 | 56 |
| Ex3 | 10.0 | 10 | 19 | 58 | 1492 | 2.0 | 56 |
| Ex4 | 10.0 | 11 | 17 | 59 | 1402 | 2.8 | 57 |
| CEx5 | 15.0 | 15 | 17 | 44 | 1971 | 1.2 | 53 |
| Ex6 | 4.5 | 16 | 19 | 50 | 1603 | 1.0 | 44 |
| Ex7 | 6.0 | 15 | 17 | 53 | 1627 | 2.4 | 54 |
| Ex8 | 6.0 | 16 | 17 | 49 | 1599 | 2.0 | 55 |
| Ex9 | 2.7 | 16 | 18 | 49 | 1546 | 1.4 | 52 |
| Ex10 | 6.0 | 16 | 18 | 54 | 1653 | 2.0 | 53 |
| Ex11 | 10.9 | 11 | 20 | 61 | 1465 | 2.4 | 55 |
| Ex12 | 8.0 | 16 | 17 | 54 | 1645 | 2.8 | 54 |
| Ex13 | 4.3 | 16 | 18 | 49 | 1899 | 1.2 | 48 |
| Ex14 | 2.9 | 15 | 14 | 56 | 1506 | 1.6 | 52 |
| CEx15 | 1.5 | 15 | 13 | 48 | 1735 | 1.0 | 45 |
| CEx16 | — | 16 | 14 | 57 | 1518 | 1.0 | 49 |
| CEx17 | — | 16 | 10 | 51 | 1881 | 1.6 | 53 |
| Ex18 | 1.1 | 16 | 10 | 60 | 1506 | 2.0 | 51 |
| Ex19 | 1.1 | 16 | 11 | 57 | 1485 | 2.0 | 51 |

MFI ratio: MFI1/MFI2 or MFI2/MFI1, whichever is larger
MFI: ISO1133-1:2011, 2.16 kg, 230° C.
Charpy: Charpy impact strength, ISO179/1eA (II)@23° C. after 7 days
Flexural modulus: ISO 178 (II)@23° C. after 7 days
Break type value and puncture energy: instrumental falling weight (IFW) test according to ISO 6603-2 at −20° C. using injection moulded plaques of 65×65×3.2 mm, a dart height of 1000 mm and a dart weight of 20 kg, average of 5 samples (YD=4, YS=3, YU, =2, NY=1)

Injection molded articles with different properties were successfully obtained from various types of masterbatch and various types of base composition.

### Ex 1 to 4, CEx 5, Ex 6: Base with Low MFI, High Impact: MB with High MFI, Low Impact

In Ex 1, pellets of a base composition comprising a second heterophasic propylene copolymer with a low MFI and a high impact strength was melt-mixed with pellets of a masterbatch consisting of a first heterophasic propylene copolymer with a high MFI and a low impact strength, an elastomer, talc and additives comprising a stabilizer. The ratio of the MFI of the first heterophasic propylene copolymer (MFI1) to the MFI of the second heterophasic propylene copolymer (MFI2) is 10. The falling dart impact properties were good in terms of both the breakage type and the puncture energy. The overall MFI, the impact strength and the flexural modulus were also good.

The compositions of Ex 2-4 are similar to Ex 1 and show similar good properties. In Ex 2, the amount of the heterophasic propylene copolymer with low MFI and high impact strength (second heterophasic propylene copolymer) is larger than that in Ex 1. The breakage type was even better than in Ex 1 while other properties were still good.

CEx 5 is similar to Ex 1 except that the masterbatch comprises a homopolymer (very high MFI, very low impact strength) instead of a heterophasic propylene copolymer (high MFI, low impact). The MFI of the homopolymer is high and the ratio of the MFI of the homopolymer to the MFI of the first heterophasic propylene copolymer is 15. The falling dart impact properties were better in Ex 1 in terms of the breakage type than in CEx 5. The impact strength was also better in Ex 1 than in CEx 5.

Ex 6 is similar to Ex 1 except that the second heterophasic propylene copolymer in the base composition was of the type having a higher MFI and a lower impact strength than that used in Ex 1. The ratio of the MFI of the first heterophasic propylene copolymer (MFI1) to the MFI of the second heterophasic propylene copolymer (MFI2) was 5. The falling dart impact properties were better in Ex 1 in terms of both the breakage type and the puncture energy than in CEx 6.

### Ex 7 to Ex 12: Base with High MFI, Low Impact; MB with Low MFI, High Impact

In Ex 7 and 8, unlike in Ex 1, the second heterophasic propylene copolymer in the base composition has a high MFI and a low impact strength while the first heterophasic propylene copolymer in the masterbatch has a low MFI and a high impact strength. The ratio of the MFI of the second heterophasic propylene copolymer (MFI2) to the MFI of the first heterophasic propylene copolymer (MFI1) is 6. Similar to Ex 1, all properties were good.

Ex 9 is similar to Ex 7 except that the heterophasic propylene copolymer with low MFI and high impact strength (first heterophasic propylene copolymer) had a higher MFI and a lower impact strength than that used in Ex 7. The ratio of the MFI of the second heterophasic propylene copolymer (MFI2) to the MFI of the first heterophasic propylene copolymer (MFI1) is 3. The falling dart impact properties were better in Ex 7 in terms of the breakage type than in CEx 9.

Ex 10 is similar to Ex 7 except that the second heterophasic propylene copolymer in the base composition was of the type having different RC and RCC2 than that used in Ex 7. Like in Ex 7, the ratio of the MFI of the second heterophasic propylene copolymer (MFI2) to the MFI of the first heterophasic propylene copolymer (MFI1) is 6. Similar to Ex 7, all properties were good.

Ex 11 is similar to Ex 10 except that the heterophasic propylene copolymer with low MFI and high impact strength (first heterophasic propylene copolymer) had a lower MFI and a high impact strength than that used in Ex 10. The ratio of the MFI of the second heterophasic propylene copolymer (MFI2) to the MFI of the first heterophasic propylene copolymer (MFI1) is 11. The amount of the heterophasic propylene copolymer with low MFI and high impact strength (first heterophasic propylene copolymer) was smaller than in Ex 10. Similar to Ex 10, all properties were good.

Ex 12 is similar to Ex 10 except that the heterophasic propylene copolymer with high MFI and low impact strength (second heterophasic propylene copolymer) had a higher MFI and different RCC2 than that used in Ex 10. The ratio of the MFI of the second heterophasic propylene copolymer (MFI2) to the MFI of the first heterophasic propylene copolymer (MFI1) is 8. Similar to Ex 10, all properties were good.

CEx 13: Base with Low MFI, Low Impact: MB with High MFI, Low Impact

CEx 13, a heterophasic propylene copolymer having a low MFI and a low impact strength was used as the base composition. A heterophasic propylene copolymer having a high MFI and a low impact strength was used in in the masterbatch. The ratio of the MFI of the heterophasic propylene copolymer in the masterbatch to the MFI of the heterophasic propylene copolymer in the base composition is 4.3. The falling dart impact properties were better in Ex 1 in terms of both the breakage type and the puncture energy than in CEx 13.

Ex 14: Base with High MFI, High Impact: MB with Low MFI, Low Impact

In CEx 14, a heterophasic propylene copolymer having a high MFI and a high impact strength was used as the base composition. A heterophasic propylene copolymer having a low MFI and a low impact strength was used in in the masterbatch. The ratio of the MFI of the heterophasic propylene copolymer in the base composition to the MFI of the heterophasic propylene copolymer in the masterbatch is 3. The ratio of the impact strength of the heterophasic propylene copolymer in the base composition to the MFI of the heterophasic propylene copolymer in the masterbatch is 3.8. The falling dart impact properties were better in Ex 1 in terms of the breakage type than in Ex 14. The overall MFI in Ex 14 is lower than that in Ex 1.

CEX 15: Base with High MFI, High Impact, MB with High MFI, High Impact

In CEx 15, the ratio of the MFI of the heterophasic propylene copolymer in the base composition to the MFI of the heterophasic propylene copolymer in the masterbatch is 1.5. The ratio of the impact strength of the heterophasic propylene copolymer in the base composition to the MFI of the heterophasic propylene copolymer in the masterbatch is 2.6. No elastomer is present in the masterbatch. The falling dart impact properties were better in Ex 1 in terms of the breakage type than in CEx 15. The overall MFI in CEx 15 is lower than that in Ex 1.

### CEX 16: no HECO in MB

In CEx 16, no HECO or elastomer is present in the masterbatch. The falling dart impact properties were better in Ex 1 in terms of the breakage type than in CEx 16. The overall MFI in CEx 16 is lower than that in Ex 1.

### CEX 17: no HECO in MB

In CEx 17, no HECO is present in the masterbatch. The falling dart impact properties were better in Ex 1 in terms of the breakage type than in CEx 16. The overall MFI in CEx 16 is lower than that in Ex 1.

### EX 18 and 19

In Ex 18 and 19, the ratio of the MFI of the heterophasic propylene copolymer in the base composition to the MFI of the heterophasic propylene copolymer in the masterbatch is 1.1. The falling dart impact properties are good in terms of the breakage type. The overall MFI is relatively low.

1. A process for the preparation of an injection molded article, wherein the process comprise the steps of:
i) providing a masterbatch by melt-mixing in an extruder a first heterophasic propylene copolymer having a first melt flow index MFI1 determined according to ISO1133-1:2011 using 2.16 kg at 230° C., an elastomer, an inorganic filler and additives comprising a stabilizer,
ii) providing a base composition comprising a second heterophasic propylene copolymer having a second melt flow index MFI2 determined according to ISO1133-1:2011 using 2.16 kg at 230° C., wherein MFI1 and MFI2 are different,
iii) providing the injection molded article using an injection molding machine comprising an extruder part and an injection molding part by melt-mixing the masterbatch and the base composition in the extruder part to obtain a melt mixture and processing the melt mixture in the injection molding part to obtain the injection molded article,
wherein the first heterophasic propylene copolymer consists of (ia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (ib) a dispersed ethylene-α-olefin copolymer, wherein the sum of the total amount of propylene-based matrix and total amount of the dispersed ethylene-α-olefin copolymer in the heterophasic propylene copolymer is 100 wt % and wherein the second heterophasic propylene copolymer consists of (iia) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (iib) a dispersed ethylene-α-olefin copolymer, wherein the sum of the total amount of propylene-based matrix and total amount of the dispersed ethylene-α-olefin copolymer in the heterophasic propylene copolymer is 100 wt %.

2. The process according to claim 1, wherein the ratio of MFI1 to MFI2 or the ratio of MFI2 to MFI1 is at least 5.0.

3. The process according to claim 1, wherein the first heterophasic propylene copolymer has a first impact strength IS1 according to ISO179/1eA (II) at 23° C. and the second heterophasic propylene copolymer has a second impact strength IS2 according to ISO179/1eA (II) at 23° C., wherein MFI1>MFI2 and IS1<IS2 or MFI1<MFI2 and IS1>IS2.

4. The process according to claim 1, wherein the first heterophasic propylene copolymer is HECO-A and the second heterophasic propylene copolymer is HECO-B or the first heterophasic propylene copolymer is HECO-B and the second heterophasic propylene copolymer is HECO-A, wherein the HECO-A has a melt flow rate as determined according to ISO1133-1:2011 using 2.16 kg at 230° C. of greater than 25 and at most 120 dg/min and a Charpy impact strength determined by ISO179/1eA (II) at 23° C. of 3.0 to 15 kJ/m2 and the HECO-B has a melt flow rate as determined according to ISO1133-1:2011 using 2.16 kg at 230° C. of 1.0 to 25 dg/min and a Charpy impact strength determined by ISO179/1eA (II) at 23° C. of at least 50 kJ/m2.

5. The process according to claim 4, wherein the amount of the ethylene-α-olefin copolymer in the HECO-A is 10 to 40 wt %, the amount of ethylene monomer units in the ethylene-α-olefin copolymer in the HECO-A is 20 to 60 wt %, the HECO-A has a soluble fraction having an intrinsic viscosity determined by an online 2-capillary viscometer according to CRYSTEX QC method of 1.50 to 3.50 dL/g and/or the HECO-A has an insoluble fraction having an intrinsic viscosity determined by an online 2-capillary viscometer according to CRYSTEX QC method of 0.85 to 1.15 dL/g.

6. The process according to claim 4, wherein the amount of the ethylene-α-olefin copolymer in the HECO-B is 20 to 50 wt %, the amount of ethylene monomer units in the ethylene-α-olefin copolymer in the HECO-B is 45 to 65 wt %, the HECO-B has a soluble fraction having an intrinsic viscosity determined by an online 2-capillary viscometer according to CRYSTEX QC method of 1.50 to 3.50 dL/g and/or the HECO-B has an insoluble fraction having an intrinsic viscosity determined by an online 2-capillary viscometer according to CRYSTEX QC method of 1.20 to 2.00 dL/g.

7. The process according to claim 1, wherein
the amount of the first heterophasic propylene copolymer with respect to the injection molded article is 10 to 50 wt %,
the amount of the elastomer with respect to the injection molded article is 5.0 to 20 wt %,
the amount of the inorganic filler with respect to the injection molded article is 5.0 to 30 wt %, and
the amount of the second heterophasic propylene copolymer with respect to the injection molded article is 30 to 80 wt %.

8. The process according to claim 1, wherein a composition consisting of the masterbatch and the base composition has a break type value of at least 1.2, wherein the break type value is determined by determining the break type of 5 samples according to instrumental falling weight (IFW) test according to ISO 6603-2 at −20° C. using injection moulded plaques of 65×65×3.2 mm, a dart height of 1000 mm and a dart weight of 20 kg where values of 4, 3, 2 and 1 are respectively assigned to break types YD, YS, YU and NY and taking the average of the five values.

9. The process according to claim 1, wherein
the amount of the first heterophasic propylene copolymer with respect to the masterbatch is 40 to 80 wt %,
the amount of the elastomer with respect to the masterbatch is 10 to 35 wt %,
the amount of the inorganic filler with respect to the masterbatch is 5.0 to 40 wt %, and
the amount of the additives with respect to the masterbatch is 0.01 to 5.0 wt %.

10. The process according to claim 1, wherein
the amount of the second heterophasic propylene copolymer with respect to the base composition is 93 to 100 wt %.

11. The process according to claim 1, wherein the weight ratio between the masterbatch and the base composition is 1:10 to 10:1.

12. The injection molded article obtained by the process according to claim 1.

13. A kit of parts for making the injection molded article according to claim 12, comprising the masterbatch and the base composition.

14. A kit of parts for making an injection molded article comprising a masterbatch and a base composition,
the masterbatch comprises a first heterophasic propylene copolymer having a first melt flow index MFI1 determined according to ISO1133-1:2011 using 2.16 kg at 230° C., an elastomer, an inorganic filler and additives comprising a stabilizer, and
the base composition comprises a second heterophasic propylene copolymer having a second melt flow index MFI2 determined according to ISO1133-1:2011 using 2.16 kg at 230° C.,
wherein MFI1 and MFI2 are different, and
wherein the masterbatch and the base composition are provided at the same time or separately.

15. A method of preparing an injection molded article with an improved break type value, the method comprising injection molding the kit according to claim 14 to form an injection molded article, wherein the break type value is determined by determining the break type of 5 samples according to instrumental falling weight (IFW) test according to ISO 6603-2 at −20° C. using injection moulded plaques of 65×65×3.2 mm, a dart height of 1000 mm and a dart weight of 20 kg where values of 4, 3, 2 and 1 are respectively assigned to break types YD, YS, YU and NY and taking the average of the five values.
